(19) United States
(12) Patent Application Publication
(10) Pub. No.: US 2022/0087215 A1
(43) Pub. Date: Mar. 24, 2022

(54) Bifurcated Pusher Blade to Move Feed Material

(71) Applicant: Samuel R. Vorpahl, Fort Atkinson, WI (US)

(72) Inventor: Samuel R. Vorpahl, Fort Atkinson, WI (US)

(21) Appl. No.: 17/478,223

(22) Filed: Sep. 17, 2021

Related U.S. Application Data
(60) Provisional application No. 63/081,027, filed on Sep. 21, 2020.

(51) Int. Cl. A01K 5/00; E02F 3/815

(52) U.S. Cl. CPC A01K 5/00; E02F 3/8155

(57) ABSTRACT

A bifurcated feed material pusher blade has a main blade with a selectively positionable wing member secured to the distal end of the main blade. The bifurcated pusher blade can be formed with two main blades connected at a forward end to a centerpiece and oriented at opposing angles relative to the direction of travel during operation. The two wing members can be independently adjustable relative to the main blades by manipulation of hydraulic cylinders. The two main blade members can be pivotally connected to the centerpiece to permit angular adjustment of the two main blades relative to the direction of travel. The frame supports extending between the two opposing main blades can be telescopic, either manually or powered by hydraulic cylinders for angular adjustment on the go, to facilitate the angular adjustment of the main blades.

### CROSS-REFERENCE TO RELATED APPLICATIONS

This application claims domestic priority on U.S. Provisional Patent Application Ser. No. 63/081,027, filed on Sep. 21, 2020, the content of which is incorporated herein in its entirety by reference.

### FIELD OF THE INVENTION

The invention disclosed in this application is directed generally to the movement of feed material for dairy or beef cattle, and more particularly, to a bifurcated, hinged feed pusher blade to position the feed material closer to the cattle to facilitate consumption thereof.

### BACKGROUND OF THE INVENTION

Dairy cows are typically housed in modern facilities known as free-stall barns. The dairy cows are restrained in longitudinal rows between which is a feed alley that is normally a horizontal concrete floor having a vertical curb adjacent to the opposing rows of dairy cows and defining the edge of a feed bunker. This vertical curb is typically between 15 inches to 18 inches in height and serves as a barrier to position the feed material at a position in which the dairy cows can access the feed. This feed alley is used as a passageway along which the feed material can be delivered against the opposing vertical curbs. In conventional free-stall barns, the rows of dairy cows and the feed lane between the rows of cows are often of a length approximately 100 feet or more in length, depending on the size of the barn. In some free-stall barns, the feed alleys can have a length of 500 feet or greater.

The current procedure for delivering feed material to the dairy cows along the opposing sides of the feed alley is to distribute the feed material from a feed mixer, wagon or truck. The delivery of the feed material is not always uniform across the entire length of the feed bunker as there is no way to accurately dispense feed evenly from feed mixers, wagons or trucks. Feed material distribution is, therefore, typically greater in some areas of the bunker and less so in other areas. During the process of consuming the feed material, cattle tend to push the feed material away as the cattle access the feed material. Accordingly, the feed material needs to be pushed closer to the cows and along the vertical barrier as an ongoing process throughout the day. Conventional devices used to move the feed material toward the cattle are angled blades mounted on tractors or skid steer loaders that engage the feed material and push the feed material toward the vertical curb, in the manner a snow plow would push snow to the side.

U.S. Pat. No. 7,481,011, granted on Jan. 27, 2009, to Clinton Nesseth, discloses a scraper blade for mounting on a skid steer loader to scrape surfaces in order to move material from one location to another, such as snow from parking lots, manure from barn alleyways and grain from large storage areas to another location. The Nesseth scraper blade is formed with a linear central section oriented perpendicular to the direction of travel and affixed to a mounting apparatus that connects to the boom arms of the skid steer loader. The central blade section has pivotally attached at each opposing end thereof a wing member that is pivotally movable through a range of movement, between a first angular position extending outboard of the central blade section to a second angular position that is oriented inboard from the corresponding end of the central blade section. The wing members are moved hydraulically, but are pivotally powered by a pair of hydraulic cylinders operating in series. The wing members are mounted at a pivot axis that is forward of the central blade section and, as a result, the wing members cannot be positioned to extend in line with the central blade portion.

U.S. Pat. No. 6,421,199, granted to Philip Quenzi, et al., on Jul. 2, 2002, discloses a snow plow having a similar configuration to the Nesseth scraper blade, except that the opposing wing members are mounted to a central blade section on pivot axes that are fixed rearwardly of the forward surface of the opposing ends of the central blade section. This pivot location enables the wing members to pivot into an angular position relative to the central blade section, but oriented forwardly thereof. The wing members are powered through hydraulic cylinders that are independently operable to move the opposing wing members, and side extensions, separately. In addition, the Quenzi blade is provided with a pair of hydraulic cylinders that extend between the mounting apparatus and the central blade section in order to pivot the central blade section into an angled position about a vertical pivot. Thus, the Quenzi plow blade can be positioned in an orientation perpendicular to the direction of travel, or angled to either the right or left.

A variable geometry bucket for handling material, such as snow, is disclosed in U.S. Pat. No. 10,132,050, granted on Nov. 20, 2018, to Forest Mandan. This bucket apparatus has a central blade section that is hinged at the center thereof to permit the left and right halves of the central blade section to be moved relative to one another from a linear configuration oriented perpendicularly to the direction of travel and angled rearwardly from the central pivot axis to form a V-shaped central blade section. In addition, a pair of wing members is pivotally connected to the opposing ends of the central blade section to be movable relative to the corresponding half of the central blade section between an orientation in line with the corresponding half of the central blade section and an orientation that is pivoted forwardly. With the multiple pivot axes, the bucket can be configured into several different orientations from a V-shaped snow plow to a box plow and to a W-shaped bucket.

A loader bucket with movable side wings is disclosed in U.S. Patent Publication No. 2006/0059727, by Lewis D. Yoder and dated Mar. 23, 2006. The structure of the bucket is somewhat similar to that of the Nesseth scraper blade, but instead of a blade, the apparatus is formed as a bucket with pivotable side wings. The side wings are mounted on opposing ends of a central bucket section that is oriented perpendicular to the direction of travel, with the respective pivot axes being positioned at the forward edge of the central bucket section. The side wings are powered by hydraulic cylinders to move between an outwardly extending position from the central bucket section to present a wider bucket configuration, but are movable into an inward position against the central bucket section to close the front side of the bucket.

U.S. Patent Publication No. 2008/0222927, by Oscar Frey, et al., and dated Sep. 18, 2008, discloses a snow plow that is provided with opposing, pivotable side members that can be positioned in line with the angled central blade section, or forward thereof to control the discharge of snow therefrom. U.S. Patent Publication No. 2009/0307941, by Robert Gamble II and dated Dec. 17, 2009, also teaches a central pivoted blade section with pivoted wing members mounted on the opposing ends of a snow plow. The wing members are powered by hydraulic cylinders and are mounted with the pivot axes along the forward line of the central blade section which permits only forward pivotal movement of the wing members relative to the central blade section from a laterally extending orientation to one pivoted forwardly of the central blade section.

It would be desirable to provide a feed pusher blade that is adapted for efficiently placing feed material into feed bunkers for access by dairy cows positioned along the side of the feed bunker.

### SUMMARY OF THE INVENTION

It is an object of this invention to overcome the disadvantages of the prior art by providing a bifurcated pusher blade to move feed material for farm animals such as cattle to position the feed material closer to the cattle to facilitate consumption thereof.

It is another object of this invention to provide a selectively positionable wing member pivotally connected to a main blade member.

It is an advantage of this invention that the pivotally adjustable wing member can be oriented to place the feed material as desired by the operator.

It is a feature of this invention that the wing member is selectively positionable by manipulation of a hydraulic cylinder interconnecting the main blade and the wing member.

It is another feature of this invention that the pusher blade is constructed in a V-shape with a main blade and associated wing member extending rearwardly from a central centerpiece member at opposing angles to the longitudinal direction of travel.

It is another advantage of this invention that the pusher blade is operable on opposing sides of a feed alley to push feed toward opposing lines of dairy cattle simultaneously.

It is still another feature of this invention that the main blades can be pivotally connected to the centerpiece to provide an angular adjustment of the main blades and associated wing members relative to the direction of travel.

It is still another object of this invention that the pusher blade can be mounted on the mounting apparatus for any prime mover, including quick attach devices on skid steer loaders and three-point hitches on tractors.

It is yet another object of this invention to provide a single blade configuration of the pusher blade having a pivotally positionable wing member.

It is yet another feature of this invention that the single blade configuration of the pusher blade can be mounted for rotation between left and right facing orientations.

It is yet another advantage of this invention that the single blade configuration of the pusher blade can be selectively operated on opposing sides of a feed bunker.

It is still another feature of this invention that the bifurcated pusher blade configuration can be utilized in a cable powered feed bunker scraper.

It is still another object of this invention to provide pusher blade for moving feed material to facilitate consumption by farm animals, such as cattle, which is easy to use, simple to manufacture and assemble, and simple and effective to use.

These and other objects, features and advantages will be found by providing a bifurcated feed material pusher blade having a main blade with a selectively positionable wing member secured to the distal end of the main blade. The bifurcated pusher blade can be formed with two main blades connected at a forward end to a centerpiece and oriented at opposing angles relative to the direction of travel during operation. The two wing members can be independently adjustable relative to the main blades by manipulation of hydraulic cylinders. The two main blade members can be pivotally connected to the centerpiece to permit angular adjustment of the two main blades relative to the direction of travel. The frame supports extending between the two opposing main blades can be telescopic, either manually or powered by hydraulic cylinders for angular adjustment on the go, to facilitate the angular adjustment of the main blades.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a rear perspective view of a bifurcated feed pusher blade incorporating the principles of the instant invention, the feed pusher blade being depicted in a V-shaped configuration with the wing members in alignment with the corresponding main blade;

FIG. 2 is a right front perspective view of the feed pusher blade shown in FIG. 1;

FIG. 3 is a left rear perspective view of the feed pusher blade depicted in FIG. 1;

FIG. 4 is a left front perspective view of the feed pusher blade with the left wing member being pivoted forwardly with respect to being aligned with the corresponding main blade;

FIG. 5 is right rear perspective view of the feed pusher blade with the right wing member being pivoted forwardly with respect to being aligned with the corresponding main blade;

FIG. 6 is a top plan view similar of the pusher blade as depicted in FIG. 4;

FIG. 7 is a right rear perspective view of the feed pusher blade depicted in FIG. 6;

FIG. 8 is an enlarged elevational view of the right main blade and pivotally connected wing member positioned in alignment with the main blade;

FIG. 9 is a perspective view of the right wing member shown in FIG. 8;

FIG. 10 is a top plan view of an alternative embodiment of the feed pusher blade in which the right and left main blade assemblies are pivotally connected to the centerpiece for angular positioning relative to the direction of travel;

FIG. 11 is a top plan view of the alternative embodiment of the feed pusher blade with the right wing member pivoted relative to the main blade;

FIG. 12 is a left front perspective view of the alternative embodiment of the feed pusher blade shown in FIG. 11;

FIG. 13 is a front perspective view of a second alternative embodiment of the feed pusher blade;

FIG. 14 is a front elevational view of the second alternative embodiment of the feed pusher blade shown in FIG. 13;

FIG. 15 is a front perspective view of the second alternative embodiment of the feed pusher blade shown in FIG. 14;

FIG. 16 is a top plan view of the second alternative embodiment of the feed pusher blade shown in FIG. 14;

FIG. 17 is a schematic top plan view of a third alternative embodiment of a bifurcated, hinged feed pusher blade mounted on the three point hitch of a tractor and having the feed pusher blade pivoted to the right for engagement of feed material;

FIG. 18 is a schematic elevational view of the third embodiment shown in FIG. 17; and

FIG. 19 is a schematic perspective view of yet another alternative embodiment of a pivoted, three-point hitch mounted feed pusher blade provided as a cable driven scraper blade for a feed bunker.

### DETAILED DESCRIPTION OF THE PREFERRED EMBODIMENT

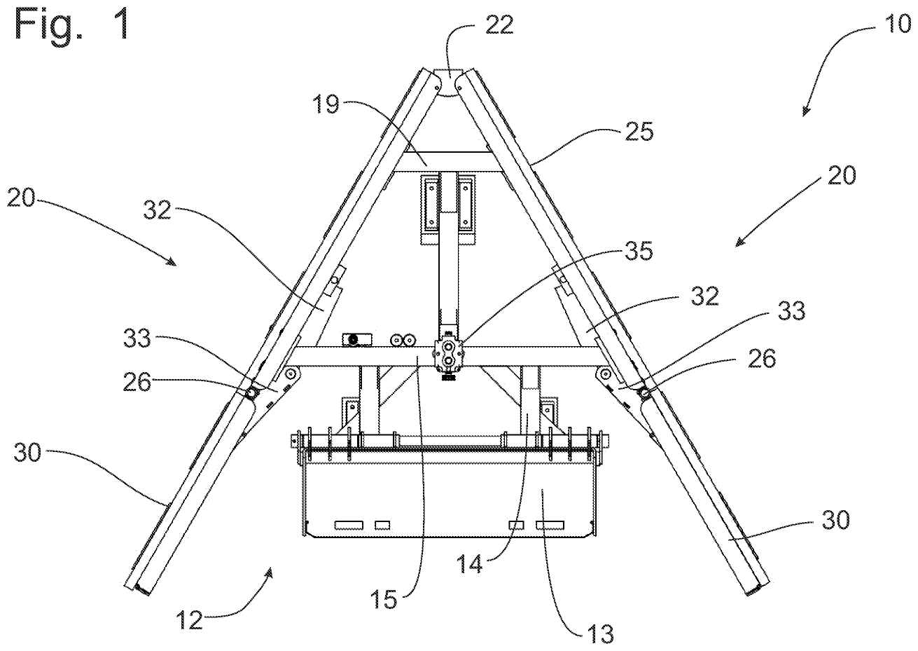

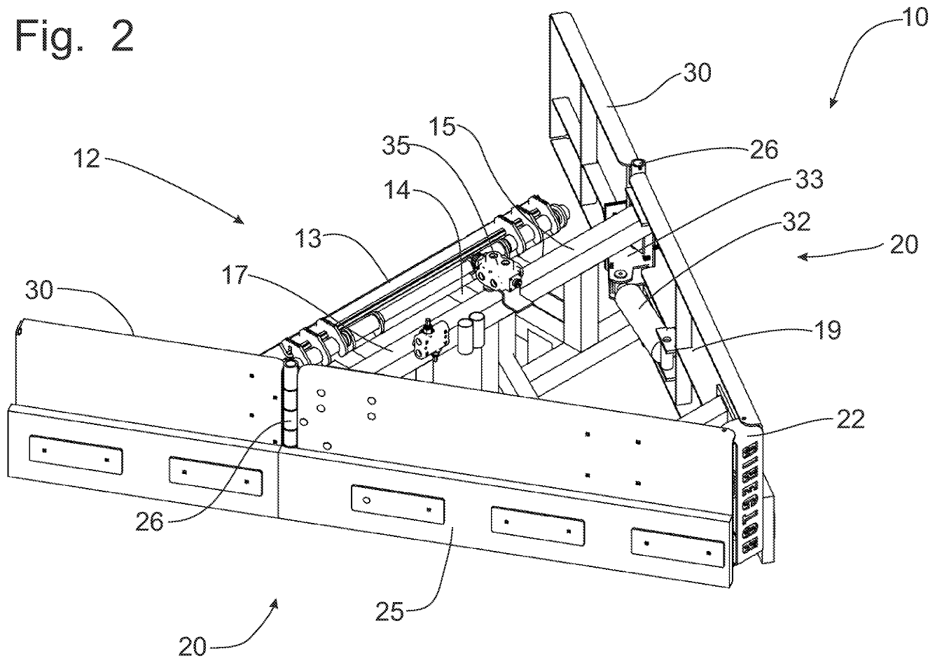

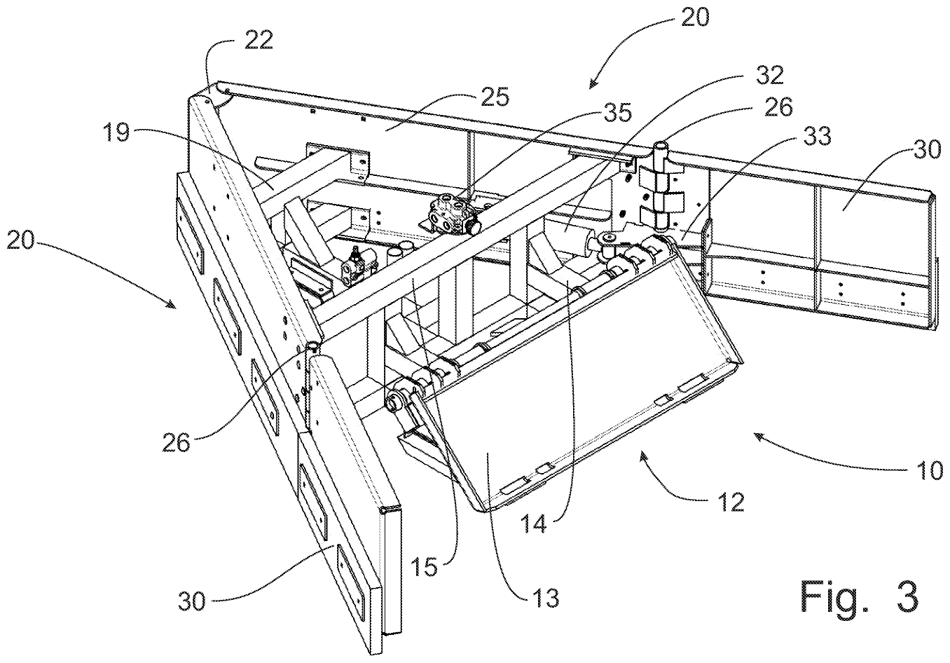

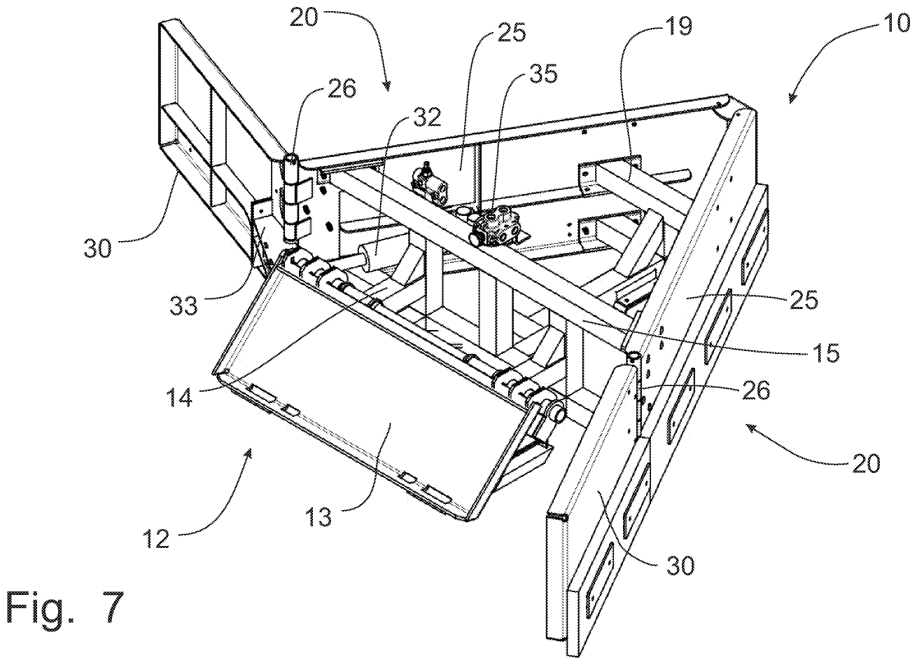

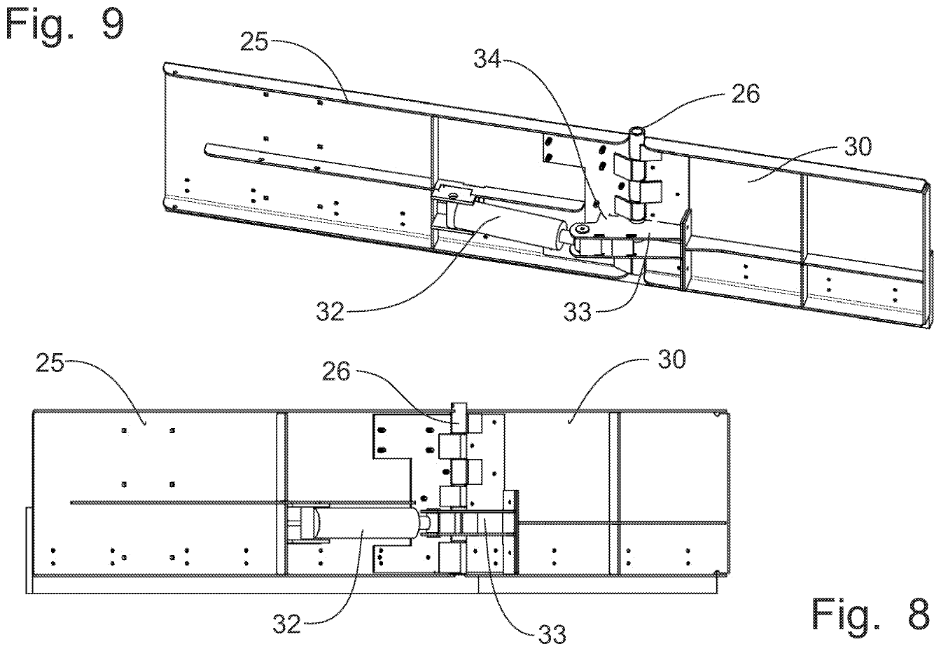

Referring to FIGS. 1-9, a bifurcated feed pusher blade incorporating the principles of the instant invention can best be seen. The pusher blade 10 includes a quick attach mounting apparatus 13 that is adapted for connection with a mounting plate (not shown) on a prime mover, such as a skid steer loader or a tractor, so that the pusher blade 10 is positioned in front of the operator of the prime mover (not shown). The mounting apparatus 13 is part of a frame 12 which supports the pusher blade 10 for movement across a floor surface, such as the feed alley in a free-stall barn (not shown). The frame 12 further includes a forwardly projecting portion 14 supported by the mounting apparatus 13 and a transversely extending frame portion 15 that is supported by the forwardly projecting portion 14 so as to be positioned forwardly of the mounting apparatus 13 and generally parallel thereto.

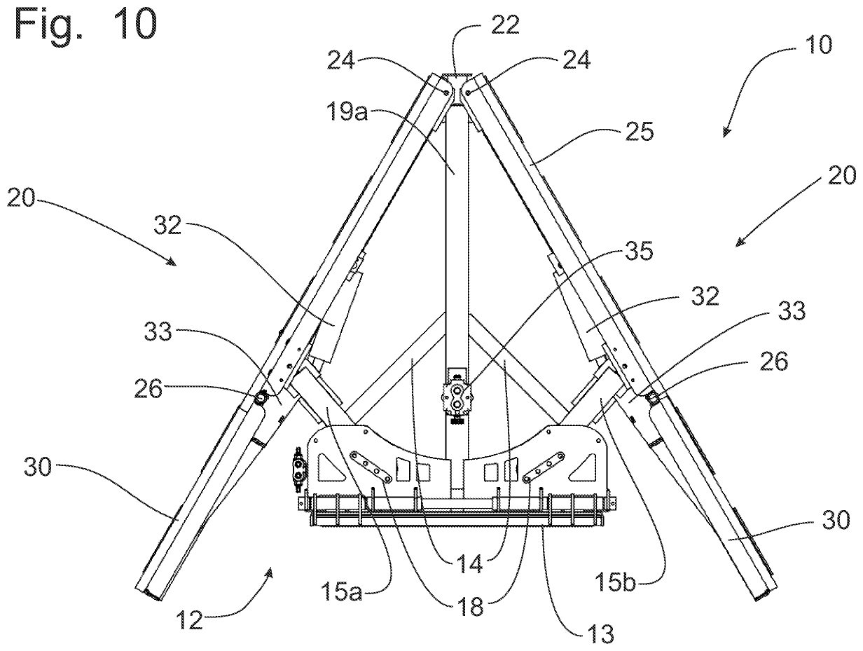

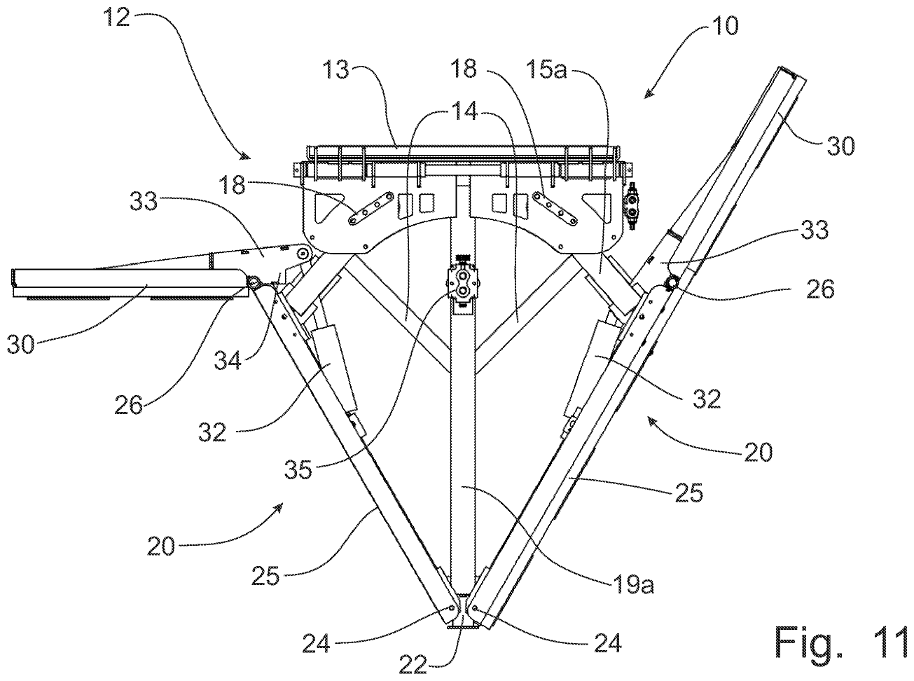

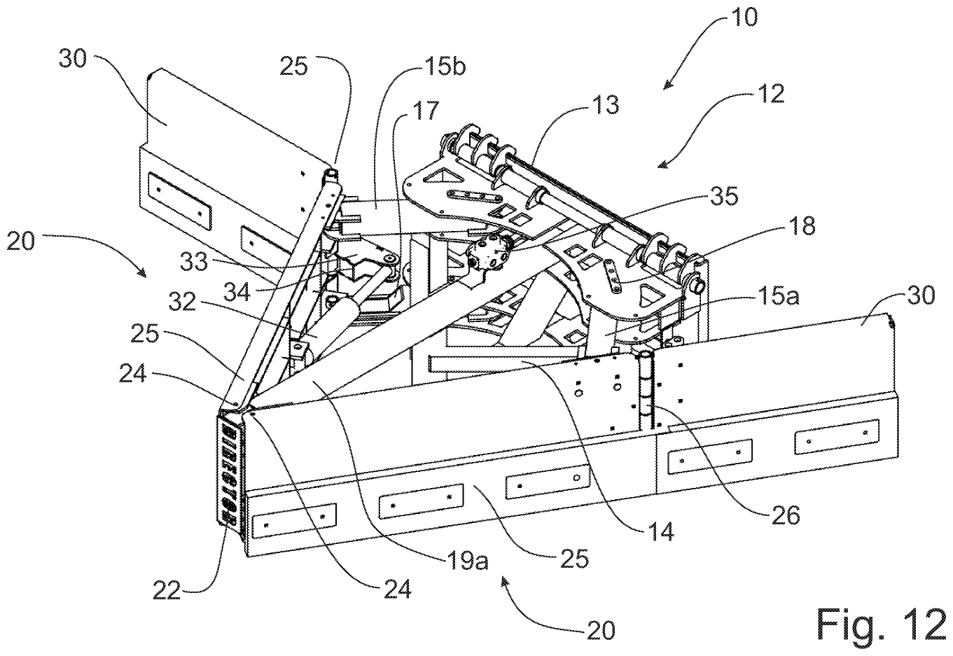

The configuration of the bifurcated feed pusher blade 10 has fixed length frame members 15, 19 interconnecting the opposing main blade members 25 such that the opposing blade assemblies 20 are not angularly adjustable. However, as can be seen in FIGS. 10-12, both the transversely extending arms 15a, 15b of the frame 12 can be telescoped relative to the frame 12 to cause movement of the blade assemblies 20 can be angularly adjustable relative to the direction of travel due to respective vertical pivots carried by the centerpiece 22. The telescoping arms would extend laterally to engage and support the opposing blade assemblies 20, as will be described in greater detail below. The telescopic extension and contraction of the frame members 15a, 15b will be described in greater detail below.

Referring again to FIGS. 1-9, each of the opposing blade assemblies 20 are joined at the forward end thereof by a centerpiece 22. Each of the blade assemblies 20 is formed with a main blade member 25 that is pivotally connected at the forward end thereof to the centerpiece 22. Each main blade member 25 carries at the rearward end thereof a vertically oriented hinge 26 which is supported at the top and bottom thereof by the upper and lower transverse frame members 15. Each blade assembly 20 further includes a wing member 30 pivotally connected to the rearward end of the main blade member 25 by the hinge 26. Each wing member 30 is powered with respect to positional adjustment by a corresponding hydraulic cylinder 32 operably connected to a hydraulic valve 35 mounted on the central portion of the frame member 15.

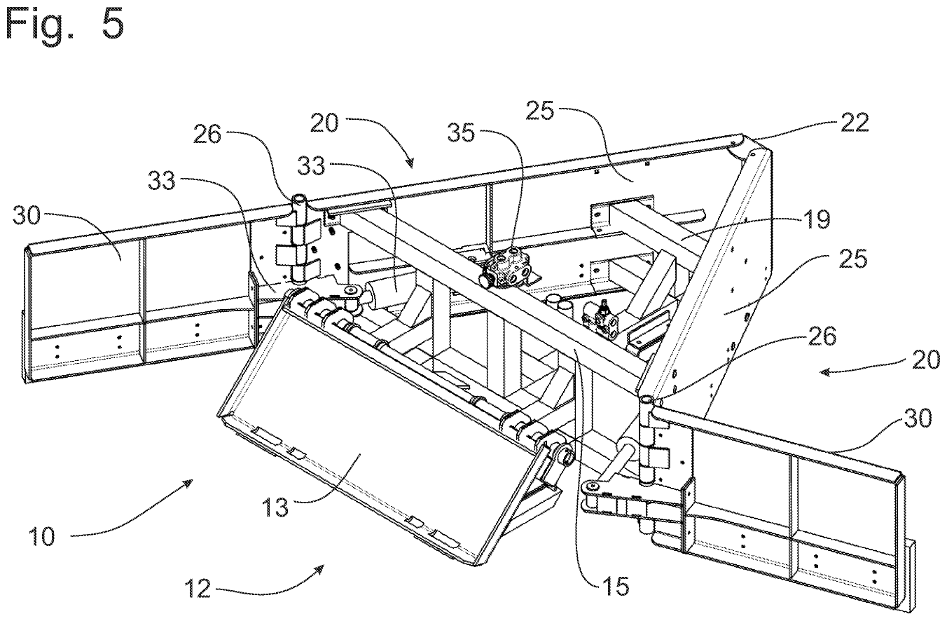

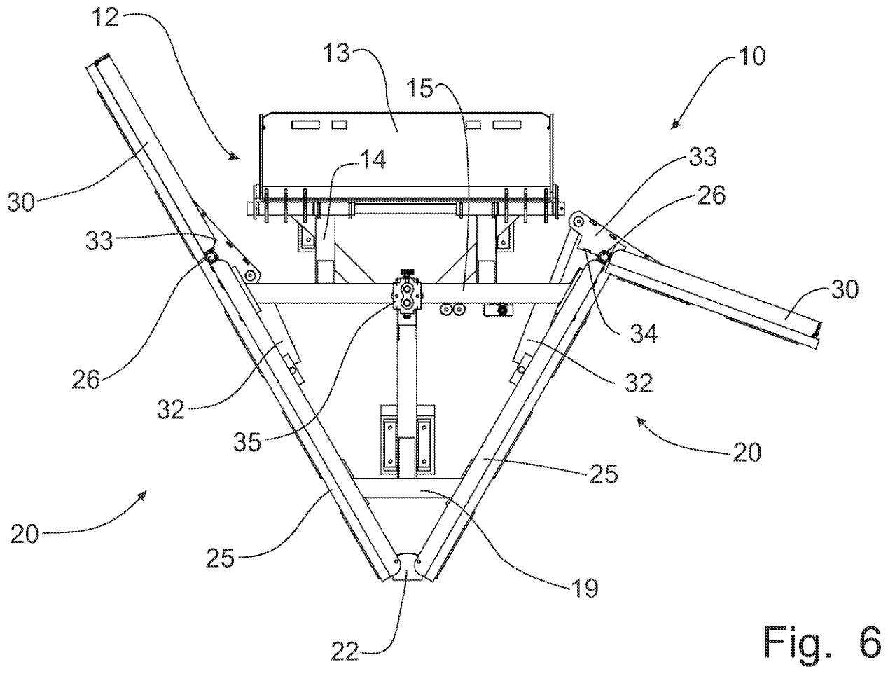

A hydraulic cylinder 32 is mounted on each of the opposing main blade member 25 and connected to a corresponding pivot bracket 33 to affect pivotal movement of the wing member 30 between a home position in alignment with the main blade member 25, as depicted in FIG. 1 to a maximum deflection position, which is at approximately 90 degrees so as to be perpendicular to the main blade member 25, as is depicted in FIG. 6. Preferably, the pivot bracket 33 includes a stop member 34, best seen in FIGS. 5 and 9, that engages the main blade member 25 when in the home position to align the main blade member 25 and the wing member 30.

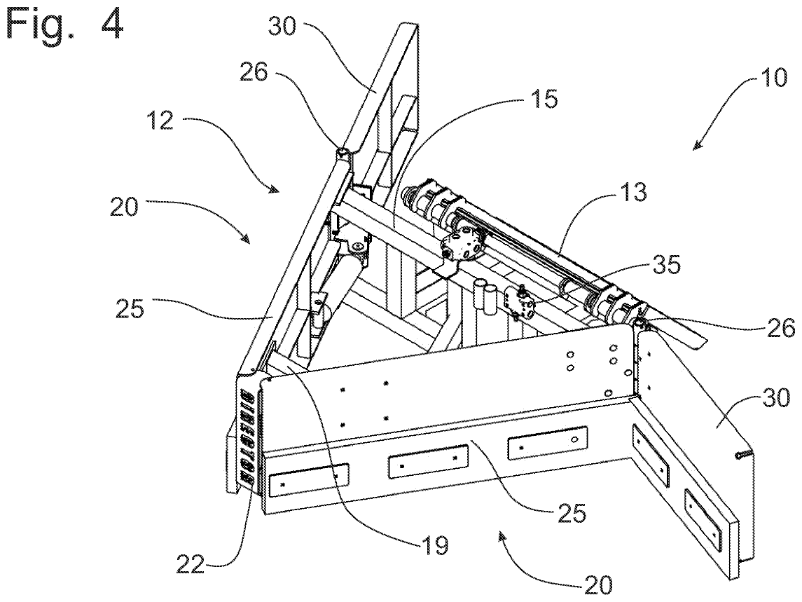

With reference to FIGS. 4 and 5, the wing member 30 can be selectively pivoted to a selected angle of deflection throughout the range between the home position and the maximum deflection position. For example, the wing member 30 can be pivoted to a deflection of approximately 15 degrees which may give the operator an ability to specifically distribute feed material into the feed bunker (not shown) to the sides of the central feed alley (not shown). The selective movement of the wing member 30 throughout the normal range of pivotal movement will enable the operator to distribute feed material in a desired manner to facilitate access thereto by the dairy cattle positioned along the feed bunker.

Referring now to the second embodiment of the feed pusher blade shown in FIGS. 10-13, each of the opposing blade assemblies 20 are joined at the forward end thereof by a centerpiece 22, which could carry a pair of hinges to define respective pivot axes for the pivotal movement of the respective blade assemblies 20 to the centerpiece 22. With each of the blade assemblies 20 being connected at the centerpiece 22 and to the telescoping arms from the transversely extending portion 15 of the frame 12, the respective blade assemblies 20 can be oriented at a selected angle of repose relative to the direction of travel of the pusher blade 10. Changes to the angle of repose of a blade assembly 20 can be accomplished by extending or contracting the telescopic arms 15a, 15b, and the associated lower arms 17 corresponding to the selected blade assembly 20.

The preferred frame 12 configuration is different from the first embodiment with fixed blade assemblies 20 shown in FIGS. 1-9, but still includes a mounting apparatus 13 for connecting the feed pusher blade 10 to a prime mover. The telescoping arms 15a, 15b are movable in a telescopic manner relative to the frame 12 toward and away from the respective blade assemblies 20. The position of the arms 15a, 15b can be pinned to the frame 12 by the locking mechanism 18, and clearly the corresponding positions of the lower telescopic arms 17 must also be secured likewise. One skilled in the art will recognize that the movement of the telescopic arms 15a, 15b and 17 can be accomplished manually, as depicted in FIGS. 10-12, as well as hydraulically or electric actuators. A longitudinally extending frame member 19a provides structural support for the centerpiece 22, while forwardly extending frame structure 14 supports the longitudinal frame member 19a.

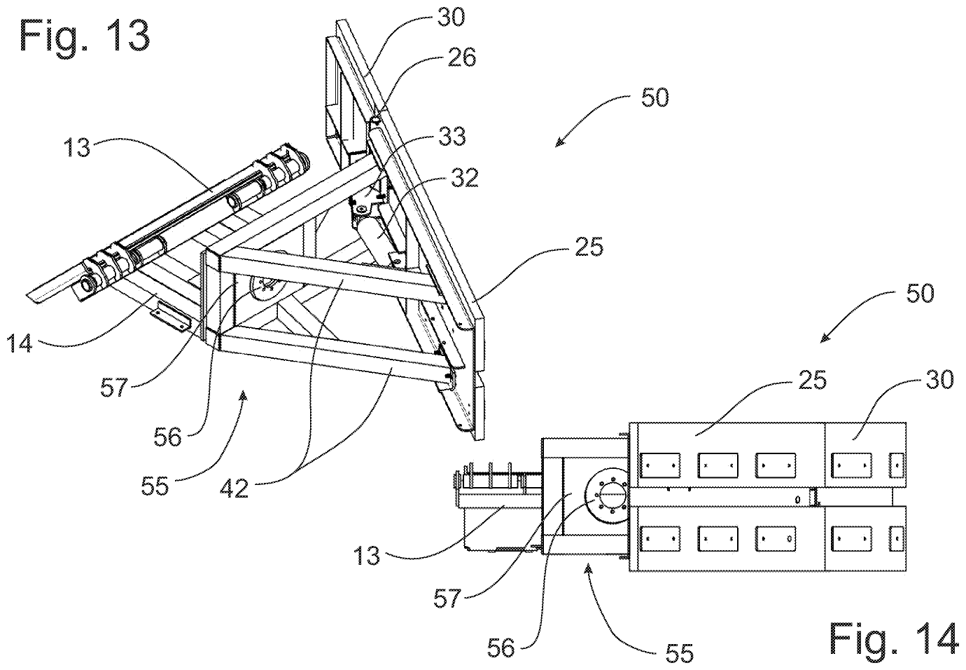

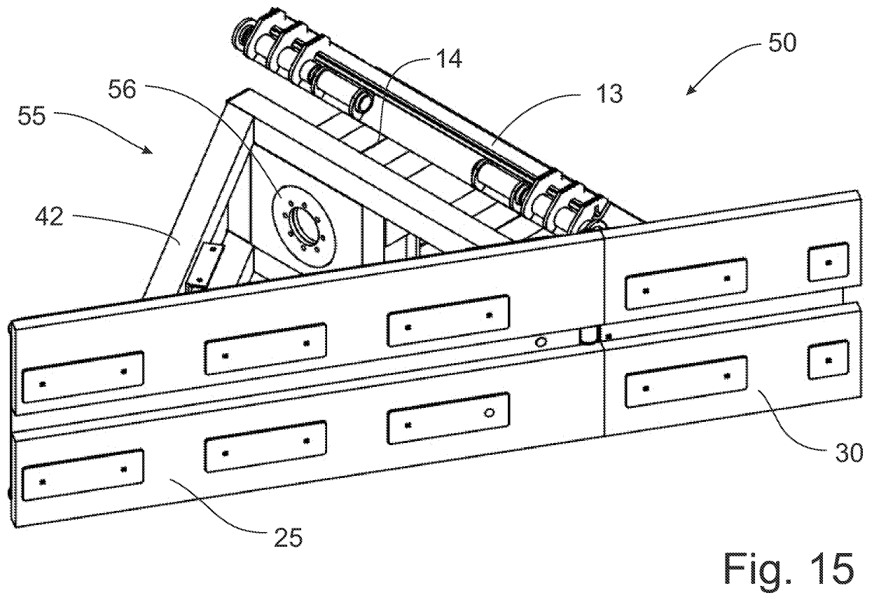

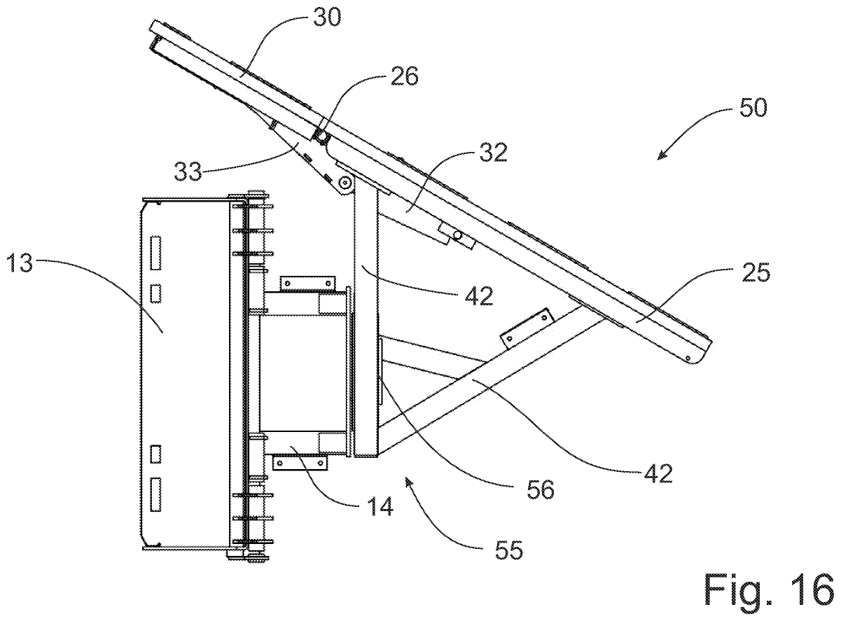

Referring now to FIGS. 13-16, a third alternative embodiment of the feed pusher blade 50 can best be seen, the configuration of the blade assembly 20, the vertical hinge 26 mounting the trailing wing member 30, and the support of the vertical hinge 26 by telescopic frame member 44, is similar to that described above with respect to the first alternative embodiment of the pusher blade 40 shown in FIG. 10. The primary difference of this alternative embodiment 50 with respect to the first embodiment of the pusher blade 10 shown in FIG. 1 is that the rearward ends of the fixed length frame members 42 and the telescopic frame members 44 are mounted to a rotation plate 55 carried by the mounting apparatus 13. The rotation plate assembly 55 includes a central, horizontally and longitudinally extending rotation shaft 56 about which a vertical mounting plate 57 rotates to move the single blade assembly 20 between a left delivery orientation and a right delivery orientation. In both the left and right delivery orientations of the blade assembly 20, the trailing wing member 30 will trail the main blade member 25.

Switching the single blade member 20 between the left and right delivery orientations involves the prime mover (not shown) lifting the pusher blade 50 sufficiently vertically above the surface of the ground to allow the rotation of the single blade assembly 20 to about the rotation shaft 56. The mounting plate 57 is then rotated about the rotation shaft 56 through 180 degrees of rotation to position the single blade assembly 20 on the right side of the mounting apparatus 13.

In operation, the feed pusher blade 10, 50 will push and distribute feed material in the feed bunker (not shown) through operation of the trailing wing member 30. Pivoting the wing member 30 through a selected angle of deflection relative to the main blade member 25 enables the operator to deliver feed material to locations within the feed bunker as needed to facilitate access thereto by the dairy cows. The first alternative embodiment of the pusher blade 50 will operate to either the left or right of the mounting apparatus 13 by virtue of the ability to rotate the single blade assembly 20 about the rotation plate assembly 55. In all of the embodiments of the pusher blade 10, 50, the main blade member 25 can be fixed into a predetermined angular orientation relative to the direction of travel or be configured so as to be angularly positionable relative to the direction of travel. In all configurations and embodiments, the wing member 30 is pivotable about the vertical hinge pivot axis 26 carried at the rearward end of the main blade member 25.

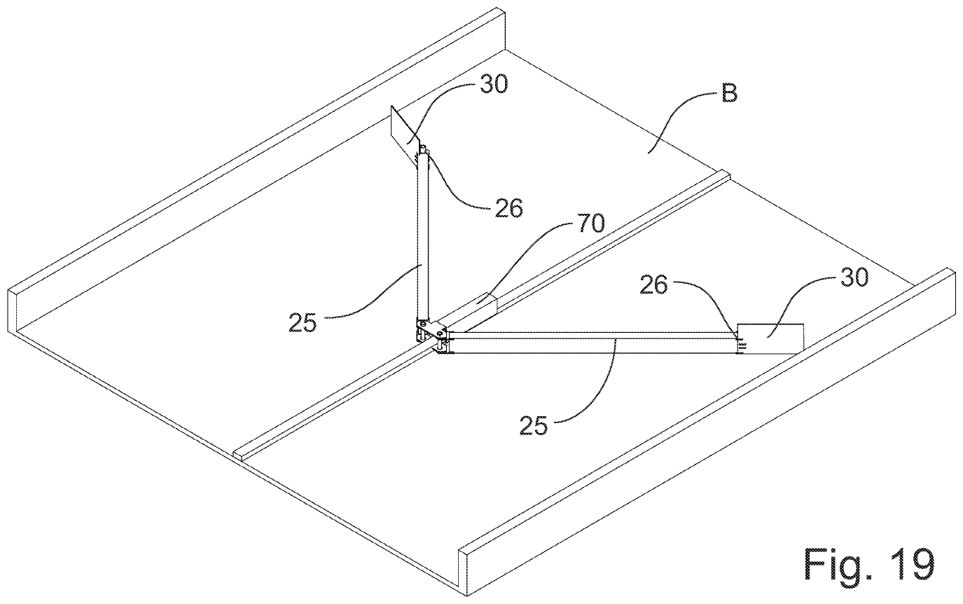

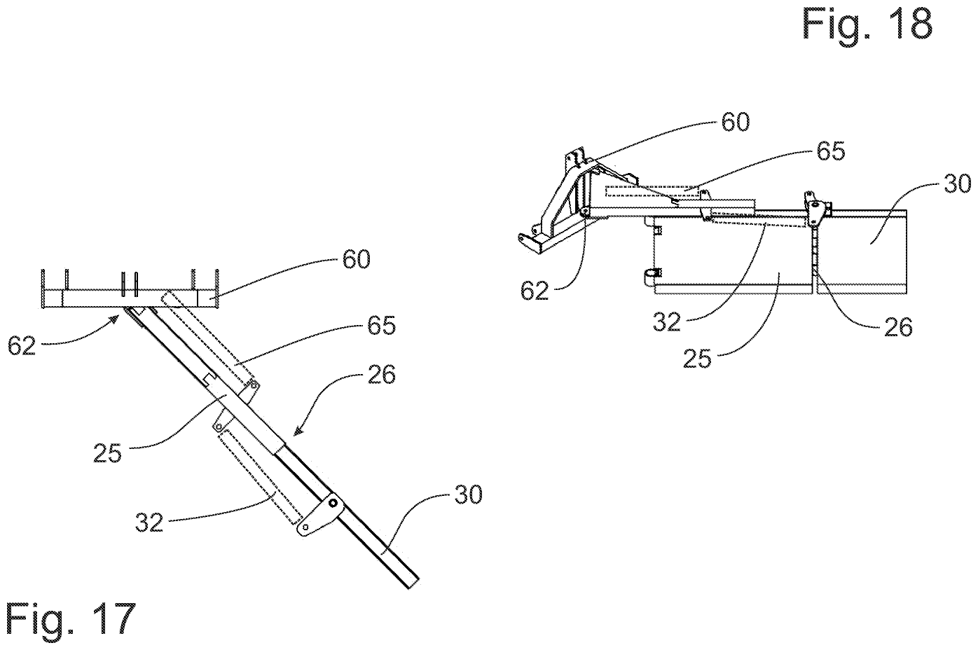

Referring now to FIGS. 17-19, alternative embodiments of a bifurcated feed pusher blade can best be seen. The first of these alternative embodiments shown in FIGS. 17 and 18 is formed with a frame 60 that is supported by the three-point hitch apparatus on a tractor or other appropriate prime mover that provides a generally vertical pivot 62 on which is mounted the pusher blade 20 for pivotal movement about a generally vertical axis. The pusher blade 20 carries at the distal end thereof a secondary pivot 26 for the pivotal mounting of the wing member 30 that is movable about the vertical pivot 26 to create a bend in pusher blade apparatus 20 that facilitates the placement of feed material, as is described in greater detail above. The wing member 30 can be positioned manually, hydraulically, electrically or otherwise to fix the wing member 30 in an angular relationship to the main pusher blade 25. The main pusher blade 25 is connected to a hydraulic cylinder 65 that extends from the frame 60 to selectively position the pusher blade 20 about the vertical pivot 62 between a right extended position, as depicted in FIG. 17 and an opposing left extended position.

The other alternative embodiment shown in FIG. 19 reflects an embodiment in which the bifurcated pusher blade can be utilized in a cable powered scraper in a feed bunker B. The head 70 is attached to a cable (not shown) in a known manner to move the head along the track in the middle of the feed bunker B. The main blade 25 is secured at a fixed angle to the head 70 with the wing member 30 at the trailing or distal end pivotally connected to the pivot 26. Accordingly, the wing member 30 can be pivoted into the desired orientation for distribution of the feed along the edges of the feed bunker for access by the animals being fed.

It will be understood that changes in the details, materials, steps and arrangements of parts, which have been described and illustrated to explain the nature of the invention will occur to and may be made by those skilled in the art upon a reading of this disclosure within the principles of the scope of the invention. The foregoing description illustrates the preferred embodiment of the invention; however, concepts, as based upon the description may be employed in other embodiments without departing from the scope of the invention. Accordingly, the following claims are intended to protect the invention broadly, as well as in the specific form shown.

Having thus described the invention, what is claimed is:

1. A pusher blade for moving and distributing material over a surface, comprising:
a frame including a mounting apparatus adapted for connection of said frame to a prime mover;
a blade assembly supported by said frame forwardly of said mounting apparatus when said mounting apparatus is connected to a forward end of said prime mover, said blade assembly being oriented at an angle of repose relative to a forward direction of movement of the pusher blade;
the blade assembly including a main blade member, supported by said frame at said angle of repose, carrying a vertical hinge member at a rearward end thereof to define a pivot axis; and
the blade assembly further including a wing member mounted to said hinge member and being pivotable between a home position in alignment with the main blade member in said angle of repose and a maximum angle of deflection moving said wing member forwardly relative to said direction of travel.

2. The pusher blade of claim 1 further comprising an actuator supported on said main blade member and connected to said wing member to power the pivotal movement of said wing member relative to said main blade member.

3. The pusher blade of claim 2 wherein first and second blade assemblies are connected to a forward centerpiece to orient said blade assemblies at opposing angles of repose relative to said direction of travel, said frame including at least one transverse frame member interconnecting said opposing blade assemblies.

4. The pusher blade of claim 2 wherein said frame further includes a rotation plate assembly that permits rotation of said blade assembly about a horizontal, longitudinally extending axis of rotation to move the blade assembly between a left delivery orientation and a right delivery orientation.

5. The pusher blade of claim 4 wherein said rotation plate assembly is supported by said mounting apparatus and includes a longitudinally oriented rotation shaft and a vertical rotation plate supported on said rotation shaft for rotation about said shaft.

6. The pusher blade of claim 3 wherein said pusher blade includes first and second blade assemblies secured at forward ends thereof by respective hinges to a centerpiece, each of said blade assemblies having a main blade member connected to said centerpiece and a trailing wing member connected to a rearward end of a respective main blade member by a vertical hinge member.

7. The pusher blade of claim 6 wherein said transvers frame member is telescopic in a lateral direction to support said opposing blade assemblies at varying angles of repose, the selected positioning of said telescopic arms defining selected angle of repose for each of the opposing first and second blade assemblies.

8. The pusher blade of claim 7 further comprising:
a pivot bracket connected to each respective wing member and to respective first and second actuators to pivot the corresponding wing member about the hinge member on which the wing member is mounted.

9. The pusher blade of claim 8 wherein each said pivot bracket is formed with a stop member that engages the corresponding main blade member when the wing member is pivoted to the home position to keep the trailing wing member in alignment with the main blade member when in the home position.

10. The pusher blade of claim 8 wherein said first and second actuators are hydraulic cylinders.

11. The pusher blade of claim 6 wherein each said blade assembly can be positioned at different angles of repose, the maximum angle of deflection for each said wing member being approximately 90 degrees to permit each said wing member to be oriented perpendicular to the corresponding said main blade member.

12. A pusher blade for moving material along a surface, comprising:
a frame including a mounting apparatus adapted for connection of said frame to a prime mover, and a transverse frame member;
first and second blade assemblies secured at forward ends thereof to a centerpiece and being supported by said frame forwardly of said mounting apparatus, said blade assemblies being oriented at respective angles of repose relative to a forward direction of movement of the pusher blade, said transverse frame member interconnecting said first and second blade assemblies to provide support thereto;
each said blade assembly including a main blade member, supported by said centerpiece and said frame in said angle of repose, and carrying a vertical hinge member at a rearward end thereof to define a pivot axis; and
each said blade assembly further including a wing member mounted to said hinge member and being pivotable between a home position in alignment with the corresponding main blade member in said angle of repose and a maximum angle of deflection moving said wing member forwardly relative to said direction of travel.

13. The pusher blade of claim 12 wherein each said blade assembly can be positioned at different angles of repose, the maximum angle of deflection for each said wing member being approximately 90 degrees to permit each said wing member to be oriented perpendicular to the corresponding said main blade member.

14. The pusher blade of claim 13 wherein said first and second blade assemblies are pivotally connected to said centerpiece about respective vertical pivots carried by said centerpiece; said transverse frame further including opposing telescopic portions connected respectively to said first and second blade assemblies, the selected positioning of said telescopic portions defining said angle of repose for each of the opposing first and second blade assemblies.

15. The pusher blade of claim 14 wherein the movement of said telescopic portions permitting selective adjustment of said angle of repose.

16. A pusher blade for moving and distributing material over a surface, comprising:
a frame including a mounting apparatus adapted for connection of said frame to a prime mover, said frame further including a transverse frame member;
a blade assembly supported by said frame forwardly of said mounting apparatus when said mounting apparatus is connected to a forward end of said prime mover, said blade assembly being positionally adjustable to orient said blade assembly at an angle of repose relative to a forward direction of movement of the pusher blade;
the blade assembly including a main blade member, supported by said frame at said angle of repose, and carrying a vertical hinge member at a rearward end thereof to define a pivot axis; and
the blade assembly further including a wing member mounted to said hinge member and being pivotable between a home position in alignment with the main blade member in said angle of repose and a maximum angle of deflection moving said wing member forwardly relative to said direction of travel.

17. The pusher blade of claim 16 further comprising an actuator supported on said main blade member and connected to said wing member to power the pivotal movement of said wing member relative to said main blade member.

18. The pusher blade of claim 17 further comprising:
a pivot bracket connected to said wing member and said actuator to pivot said wing member about said hinge member, said pivot bracket being formed with a stop member engagable with said main blade member when the wing member is pivoted to the home position to keep the trailing wing member in alignment with the main blade member.

19. The pusher blade of claim 18 wherein first and second blade assemblies are connected to a forward centerpiece to orient said blade assemblies at opposing angles of repose relative to said direction of travel.

20. The pusher of claim 17 wherein said frame further includes a rotation plate assembly that permits rotation of said blade assembly about a horizontal, longitudinally extending axis of rotation to move the blade assembly between a left delivery orientation and a right delivery orientation.
